(19) United States
(12) Patent Application Publication
(10) Pub. No.: US 2025/0303465 A1
(43) Pub. Date: Oct. 2, 2025

(54) Additive Manufacturing Powder And Additively Manufactured Body

(71) Applicant: SEIKO EPSON CORPORATION, Tokyo (JP)

(72) Inventors: Keisuke AIDA, Hachinohe (JP); Toshiki SANO, Hachinohe (JP)

(21) Appl. No.: 19/090,744

(22) Filed: Mar. 26, 2025

(30) Foreign Application Priority Data
Mar. 27, 2024 (JP) 2024-052115

(51) Int. Cl. B22F 1/065; B22F 10/14; B33Y 70/00; B33Y 80/00

(52) U.S. Cl. CPC B22F 1/065; B22F 10/14; B33Y 70/00; B22F 2301/35; B22F 2304/10; B33Y 80/00

(57) ABSTRACT

An additive manufacturing powder containing an Fe-based metal material and used in a binder jet method, in which a particle diameter D50 is 1.0 μm or more and less than 15.0 μm, and a particle diameter difference D90−D10 between a particle diameter D90 and a particle diameter D10 is 5.0 μm or more and 18.0 μm or less, a specific surface area is 0.05 [m²/g] or more and 0.25 [m²/g] or less, an average circularity is 0.85 or more and 0.99 or less, and when a plurality of droplets of a total of 1.36 mL of an evaluation PVP aqueous solution are dropped at the same position on an evaluation powder layer compacted to have a relative density of 45% or more and 47% or less and a thickness of 10 mm, a depth to which the evaluation PVP aqueous solution permeates is 110 μm or more and 250 μm or less.

The present application is based on, and claims priority from JP Application Serial Number 2024-052115, filed Mar. 27, 2024, the disclosure of which is hereby incorporated by reference herein in its entirety.

### BACKGROUND

### 1. Technical Field

The disclosure relates to an additive manufacturing powder and an additively manufactured body.

### 2. Related Art

As a technique for modeling a three-dimensional object, an additive manufacturing method using a metal powder is widely used in recent years. As the additive manufacturing method, fused deposition modeling (FDM), selective laser sintering (SLS), a binder jet method, and the like are known according to a principle of bonding.

JP-A-2016-102229 discloses a modeling metal powder that contains a large number of particles, in which the particles include at least one of Ni, Fe, and Co, a total content of Ni, Fe, and Co is 50 mass % or more, a ratio P1 of the number of particles having a circularity of less than 0.80 to the total number of particles is 10% or less, and a ratio P3 of the number of particles having a circularity of 0.95 or more to the total number of particles is 50% or more.

According to such a modeling metal powder, since a large number of particles having a large circularity are contained, a modeled object having excellent handleability and high strength can be produced.

By sintering a produced green body, a metal sintered body can be efficiently produced.

However, the modeling metal powder disclosed in JP-A-2016-102229 has a particle diameter D50 corresponding to an average particle diameter of 15 μm or more, which is relatively large. Therefore, there is a problem that the obtained modeled object has low metal powder sinterability. In addition, as the particle diameter decreases, flowability of the powder tends to decrease, and fillability of the powder tends to decrease. Therefore, when the particle diameter is reduced to improve the sinterability, it is necessary to improve the flowability of the powder. Further, as the particle diameter decreases, a surface area of the powder increases. Thus, depending on a surface state of the particles constituting the powder, permeability to an aqueous binder solution may decrease. When the permeability decreases, shape accuracy of the green body decreases.

### SUMMARY

Therefore, an object is to obtain an additive manufacturing powder that has both favorable sinterability and favorable flowability, and has favorable permeability to an aqueous binder solution.

An additive manufacturing powder according to an application example of the disclosure is
an additive manufacturing powder for use in a binder jet method, containing:
an Fe-based metal material, in which
in a volume-based cumulative particle size distribution curve measured using a laser diffraction method, a particle diameter D50 is 1.0 μm or more and less than 15.0 μm, and a particle diameter difference D90-D10 between a particle diameter D90 and a particle diameter D10 is 5.0 μm or more and 18.0 μm or less, where D10 is a particle diameter when a cumulative value from a small diameter side is 10%, D50 is a particle diameter when the cumulative value from the small diameter side is 50%, and D90 is a particle diameter when the cumulative value from the small diameter side is 90%,
a specific surface area is 0.05 [m²/g] or more and 0.25 [m²/g] or less,
an average circularity is 0.85 or more and 0.99 or less, and
when a plurality of droplets of a total of 1.36 mL of an evaluation PVP aqueous solution are dropped at a same position on an evaluation powder layer compacted to have a relative density of 45% or more and 47% or less and a thickness of 10 mm, a depth to which the evaluation PVP aqueous solution permeates is 110 μm or more and 250 μm or less.

An additively manufactured body according to an application example of the disclosure contains:
the additive manufacturing powder according to the application example of the disclosure; and
a binder binds particles of the additive manufacturing powder.

### BRIEF DESCRIPTION OF THE DRAWINGS

FIG. 1 is a process diagram showing a method for producing an additively manufactured body.

FIG. 2 shows the method for producing an additively manufactured body shown in FIG. 1.

FIG. 3 shows the method for producing an additively manufactured body shown in FIG. 1.

FIG. 4 shows the method for producing an additively manufactured body shown in FIG. 1.

FIG. 5 shows the method for producing an additively manufactured body shown in FIG. 1.

FIG. 6 shows the method for producing an additively manufactured body shown in FIG. 1.

FIG. 7 shows the method for producing an additively manufactured body shown in FIG. 1.

FIG. 8 shows the method for producing an additively manufactured body shown in FIG. 1.

FIG. 9 shows the method for producing an additively manufactured body shown in FIG. 1.

FIG. 10 shows the method for producing an additively manufactured body shown in FIG. 1.

FIG. 11 is a cross-sectional view showing a method for measuring a depth to which an evaluation PVP aqueous solution permeates an evaluation powder layer.

### DESCRIPTION OF EMBODIMENTS

Hereinafter, an additive manufacturing powder and an additively manufactured body in the disclosure will be described in detail based on an embodiment shown in the accompanying drawings.

### 1. Method for Producing Additively Manufactured Body

First, a method for producing an additively manufactured body using an additive manufacturing powder will be described.

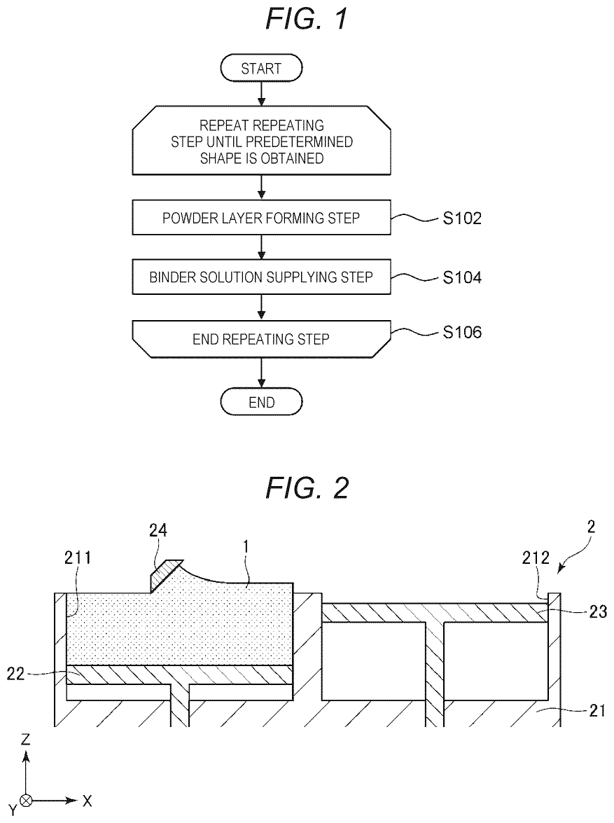

FIG. 1 is a process diagram showing the method for producing an additively manufactured body. FIGS. 2 to 10 show the method for producing an additively manufactured body shown in FIG. 1. In FIGS. 2 to 10, three axes orthogonal to each other are set as an X-axis, a Y-axis, and a Z-axis. Each axis is indicated by an arrow, and a tip side thereof is referred to as a “plus side” whereas a base side thereof is referred to as a “minus side”. In the following description, in particular, a plus side of the Z-axis is referred to as “upper”, and a minus side of the Z-axis is referred to as “lower”. In addition, both directions parallel to the X-axis are referred to as an X-axis direction, both directions parallel to the Y-axis are referred to as a Y-axis direction, and both directions parallel to the Z-axis are referred to as a Z-axis direction.

The method for producing an additively manufactured body shown in FIGS. 1 to 10 is a method called a binder jet method, which is a type of an additive manufacturing method, and includes a powder layer forming step S102, a binder solution supplying step S104, and a repeating step S106 as shown in FIG. 1. The binder jet method does not need any support structure for supporting a modeled object, and thus has an advantage that an additively manufactured body having a complicated shape can be produced.

In the powder layer forming step S102, an additive manufacturing powder 1 is spread to form a powder layer 31. In the binder solution supplying step S104, a binder solution 4 is supplied to a predetermined region of the powder layer 31, and particles in the powder layer 31 are bound to each other to obtain a bound layer 41. In the repeating step S106, the powder layer forming step S102 and the binder solution supplying step S104 are repeated once or more to obtain an additively manufactured body 6 shown in FIG. 10. Hereinafter, each step will be sequentially described.

The produced additively manufactured body 6 is subjected to a sintering treatment to form a metal sintered body. Accordingly, a metal sintered body having a complicated shape can be efficiently produced.

### 1.1. Additive Manufacturing Apparatus

First, an additive manufacturing apparatus 2 used for producing the additively manufactured body 6 will be described.

As shown in FIGS. 2 to 10, the additive manufacturing apparatus 2 includes an apparatus main body 21 including a powder storage unit 211 and a modeling unit 212, a powder supply elevator 22 provided at the powder storage unit 211, a modeling stage 23 provided at the modeling unit 212, and a coater 24, a roller 25, and a liquid supply unit 26 which are movably provided on the apparatus main body 21.

The powder storage unit 211 is a recess which is provided at the apparatus main body 21 and an upper portion of which opens. The additive manufacturing powder 1 is stored in the powder storage unit 211. An appropriate amount of the additive manufacturing powder 1 stored in the powder storage unit 211 is supplied to the modeling unit 212 by the coater 24.

The powder supply elevator 22 is disposed at a bottom portion of the powder storage unit 211. The powder supply elevator 22 is movable in an upper-lower direction in a state in which the additive manufacturing powder 1 is placed thereon. By moving the powder supply elevator 22 upward, the additive manufacturing powder 1 placed on the powder supply elevator 22 is pushed up to protrude from the powder storage unit 211. Accordingly, a protruding part of the additive manufacturing powder 1 can be moved toward the modeling unit 212.

The modeling unit 212 is a recess which is provided at the apparatus main body 21 and an upper portion of which opens. The modeling stage 23 is disposed inside the modeling unit 212. On the modeling stage 23, the additive manufacturing powder 1 is spread in layers by the coater 24. The modeling stage 23 is movable in the upper-lower direction in a state in which the additive manufacturing powder 1 is spread thereon. By appropriately setting a height of the modeling stage 23, an amount of the additive manufacturing powder 1 spread on the modeling stage 23 can be adjusted.

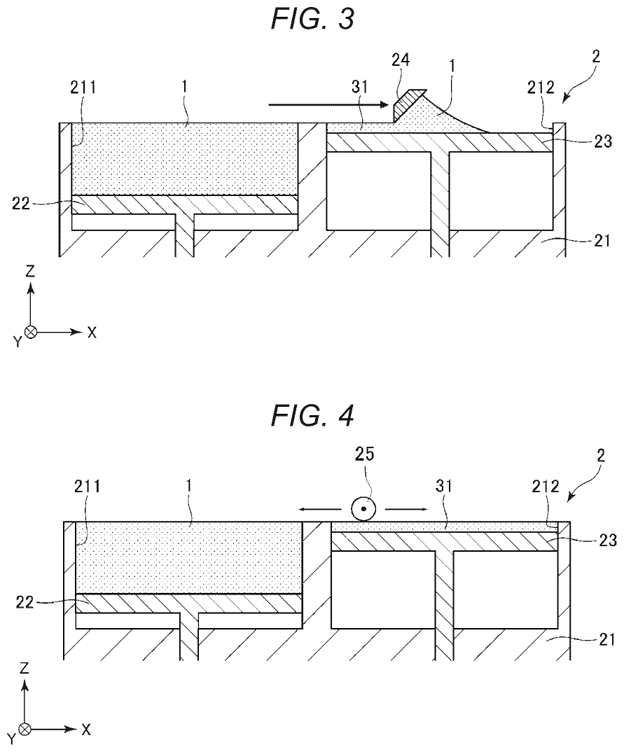

As shown in FIGS. 3 and 4, the coater 24 and the roller 25 are movable in the X-axis direction from the powder storage unit 211 to the modeling unit 212. The coater 24 can level and spread the additive manufacturing powder 1 in a layered manner by dragging the additive manufacturing powder 1. The roller 25 compresses the uniformly distributed additive manufacturing powder 1 from above.

The liquid supply unit 26 is implemented by, for example, an inkjet head and a dispenser, and is movable in the X-axis direction and the Y-axis direction at the modeling unit 212. The liquid supply unit 26 can supply an intended amount of the binder solution 4 to an intended position. The liquid supply unit 26 may include a plurality of ejection nozzles at one head. The binder solution 4 may be ejected simultaneously or with a time difference from the plurality of ejection nozzles.

### 1.2. Powder Layer Forming Step

Next, the powder layer forming step S102 using the additive manufacturing apparatus 2 will be described. In the powder layer forming step S102, the additive manufacturing powder 1 is spread on the modeling stage 23 to form the powder layer 31. Specifically, as shown in FIGS. 2 and 3, using the coater 24, the additive manufacturing powder 1 stored in the powder storage unit 211 is dragged onto and leveled on the modeling stage 23 to have a uniform thickness. Accordingly, the powder layer 31 shown in FIG. 4 is obtained. At this time, a thickness of the powder layer 31 can be adjusted by lowering an upper surface of the modeling stage 23 below an upper end of the modeling unit 212 and adjusting a lowering amount. As will be described later, the additive manufacturing powder 1 is a powder having excellent fillability when being leveled. Therefore, the powder layer 31 having a high filling ratio can be obtained.

Next, as shown in FIG. 4, the roller 25 is moved in the X-axis direction while compressing the powder layer 31 in a thickness direction by the roller 25. Accordingly, a filling ratio of the additive manufacturing powder 1 in the powder layer 31 can be increased. The compression by the roller 25 may be performed as necessary, and may be omitted. The powder layer 31 may be compressed by a device different from the roller 25, such as a pressing plate.

### 1.3. Binder Solution Supplying Step

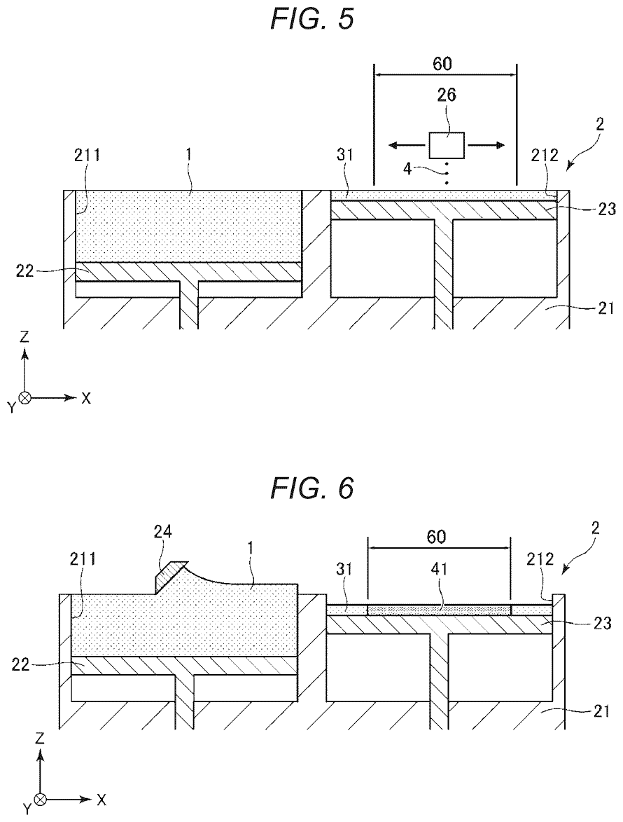

In the binder solution supplying step S104, as shown in FIG. 5, the liquid supply unit 26 supplies the binder solution 4 to a forming region 60 corresponding to the additively manufactured body 6 to be modeled in the powder layer 31. The binder solution 4 is a liquid containing a binder and water (aqueous binder solution). In the forming region 60 to which the binder solution 4 is supplied, particles of the additive manufacturing powder 1 are bound to each other, and the bound layer 41 shown in FIG. 6 is obtained. In the bound layer 41, the particles of the additive manufacturing powder 1 are bound to each other with the binder, and the bound layer 41 has shape retention performance to an extent that the bound layer 41 is not broken by own weight.

The bound layer 41 may be heated simultaneously with or after the supply of the binder solution 4. Accordingly, volatilization of a solvent or a dispersion medium contained in the binder solution 4 is promoted, and solidification or curing of the binder promotes binding of the particles. When the binder contains a photo-curable resin or a UV-curable resin, light irradiation or UV irradiation may be performed instead of heating or together with heating.

A heating temperature in the heating is not particularly limited, and is preferably 50° C. or higher and 250° C. or lower, and more preferably 70° C. or higher and 200° C. or lower. Accordingly, a sufficient amount of heat can be applied to the bound layer 41, and the volatilization of the solvent or the dispersion medium can sufficiently be promoted.

The binder solution 4 may contain another solvent together with water. Examples of the solvent include alcohols, ketones, and carboxylic acid esters, and at least one of the above is used. Examples of the binder contained in the binder solution 4 include fatty acids, paraffin waxes, microcrystalline waxes, polyethylene, polypropylene, polystyrene, acrylic resins, polyamide resins, polyesters, stearic acid, polyvinyl pyrrolidone (PVP), polyvinyl alcohol (PVA), polyethylene glycol (PEG), urethane resins, epoxy resins, vinyl resins, unsaturated polyester resins, and phenolic resins.

### 1.4. Repeating Step

In the repeating step S106, the powder layer forming step S102 and the binder solution supplying step S104 are repeated once or more until a stacked body formed by stacking plurality of bound layers 41 has a predetermined shape. That is, these steps are performed 2 or more times in total. Accordingly, the three-dimensional additively manufactured body 6 shown in FIG. 10 is obtained.

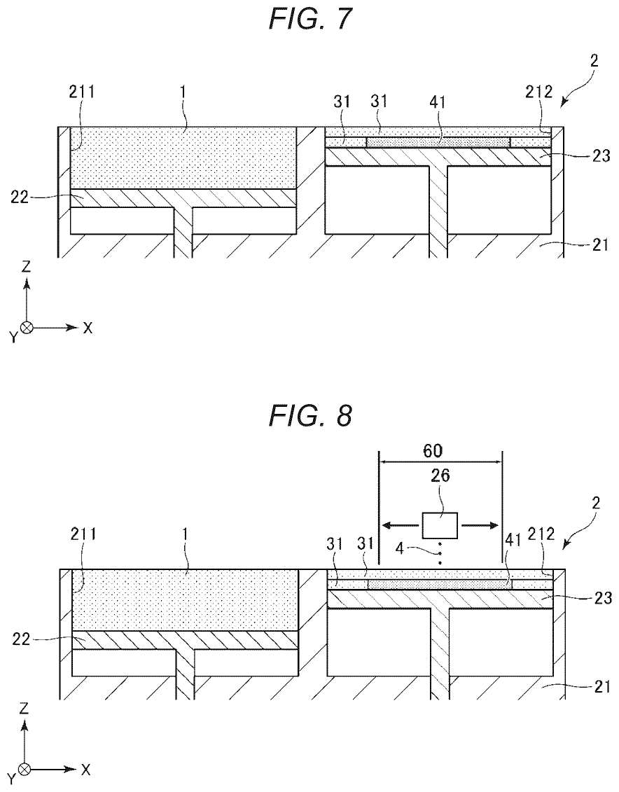

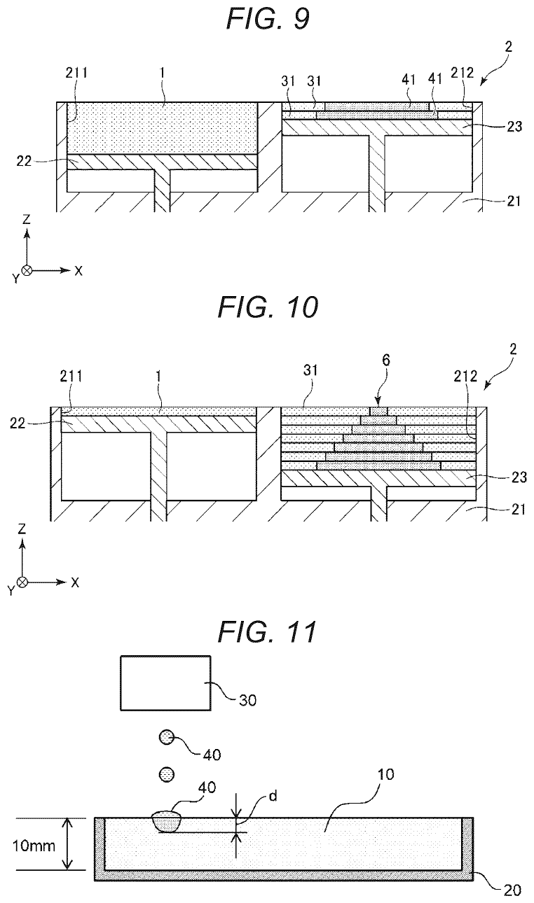

Specifically, first, as shown in FIG. 7, a new powder layer 31 is formed on the bound layer 41 shown in FIG. 6. Next, as shown in FIG. 8, the binder solution 4 is supplied to the forming region 60 in the newly formed powder layer 31. Accordingly, the bound layer 41 as a second layer shown in FIG. 9 is obtained. By repeating such operations, the additively manufactured body 6 shown in FIG. 10 is obtained.

In the powder layer 31, the additive manufacturing powder 1 that does not constitute the bound layers 41 is collected and reused as necessary, that is, used again for producing the additively manufactured body 6.

The additively manufactured body 6 obtained as described above is subjected to the sintering treatment to be described later.

### 1.5. Method for Producing Metal Sintered Body

By subjecting the additively manufactured body 6 to the sintering treatment, the metal sintered body is obtained. In the sintering treatment, the additively manufactured body 6 is heated to cause a sintering reaction. A sintering temperature varies depending on a constituent material, a particle diameter, and the like of the additive manufacturing powder 1, and as an example, is preferably 980° C. or higher and 1330° C. or lower, and more preferably 1050° C. or higher and 1260° C. or lower. A sintering time is preferably 0.2 hours or longer and 7 hours or shorter, and more preferably 1 hour or longer and 6 hours or shorter.

An atmosphere in the sintering treatment is, for example, a reducing atmosphere such as hydrogen, an inert atmosphere such as nitrogen or argon, or a reduced-pressure atmosphere obtained by reducing a pressure of such an atmosphere. The pressure in the reduced-pressure atmosphere is not particularly limited as long as the pressure is lower than a normal pressure (100 kPa), and is preferably 10 kPa or less, and more preferably 1 kPa or less.

When the sintering treatment performed under the above-described conditions is referred to as “main sintering”, “pre-sintering” or “debindering” corresponding to a pretreatment of the main sintering may be performed on the additively manufactured body 6 as necessary. Accordingly, at least a part of the binder contained in the additively manufactured body 6 can be removed, or a sintering reaction can be caused in a portion. Accordingly, when the main sintering is performed, unintended deformation or the like can be prevented.

A temperature in the pre-sintering or the debindering is not particularly limited as long as the temperature is a temperature at which sintering of a metal powder is not completed, and is preferably 100° C. or higher and 500° C. or lower, and more preferably 150° C. or higher and 300° C. or lower. A duration of the pre-sintering or the debindering in the temperature range described above is preferably 5 minutes or longer, more preferably 10 minutes or longer and 120 minutes or shorter, and still more preferably 20 minutes or longer and 60 minutes or shorter. An atmosphere in the pre-sintering or the debindering is, for example, an ambient atmosphere, an inert atmosphere such as nitrogen or argon, or a reduced-pressure atmosphere obtained by reducing a pressure of such an atmosphere.

The metal sintered body obtained as described above can be used as a material constituting all or a part of a component for transportation equipment such as a component for an automobile, a component for a bicycle, a component for a railway vehicle, a component for a ship, a component for an aircraft, or a component for a spacecraft, a component for an electronic device such as a component for a personal computer, a component for a mobile phone terminal, a component for a tablet terminal, or a component for a wearable terminal, a component for electrical equipment such as a refrigerator, a washing machine, or a cooling and heating machine, a component for a machine such as a machine tool or a semi-conductor manufacturing apparatus, a component for a plant such as a nuclear power plant, a thermal power plant, a hydroelectric power plant, an oil refinery, or a chemical complex, and a decorative item such as a component for a timepiece, a metal utensil, jewelry or an eyeglass frame.

### 2. Additive Manufacturing Powder

Next, the additive manufacturing powder according to the embodiment will be described.

The additive manufacturing powder 1 according to the embodiment is a powder used in a binder jet method.

### 2.1. Constituent Material

The additive manufacturing powder 1 contains an Fe-based metal material. The Fe-based metal material refers to a metal material having an Fe content of more than 50% in terms of an atomic ratio.

Examples of the Fe-based metal material include stainless steel such as austenitic stainless steel, ferritic stainless steel, martensitic stainless steel, precipitation-hardening stainless steel, and austenitic-ferritic (duplex) stainless steel, low-carbon steel, carbon steel, heat-resistant steel, die steel, high-speed tool steel, an Fe—Ni alloy, and an Fe—Ni—Co alloy.

Among these, stainless steel is preferably used as the Fe-based metal material. Stainless steel is a type of steel excellent in mechanical strength and corrosion resistance. Therefore, by using the additive manufacturing powder 1 made of stainless steel, a metal sintered body having excellent mechanical strength and corrosion resistance and having high shape accuracy can be efficiently produced.

Among the types of stainless steel, precipitation-hardening stainless steel is particularly preferably used. The precipitation-hardening stainless steel has excellent mechanical strength and toughness due to formation of a precipitate.

Examples of the austenitic steel include SUS301, SUS301L, SUS301J1, SUS302B, SUS303, SUS304, SUS304Cu, SUS304L, SUS304N1, SUS304N2, SUS304LN, SUS304J1, SUS304J2, SUS305, SUS309S, SUS310S, SUS312L, SUS315J1, SUS315J2, SUS316, SUS316L, SUS316N, SUS316LN, SUS316Ti, SUS316J1, SUS316J1L, SUS317, SUS317L, SUS317LN, SUS317J1, SUS317J2, SUS836L, SUS890L, SUS321, SUS347, SUSXM7, and SUSXM15J1.

Examples of the ferritic stainless steel include SUS405, SUS410L, SUS429, SUS430, SUS430LX, SUS430J1L, SUS 434, SUS 436L, SUS436J1L, SUS445J1, SUS445J2, SUS444, SUS447J1, and SUSXM27.

Examples of the martensitic stainless steel include SUS403, SUS410, SUS410S, SUS420J1, SUS420J2, and SUS440A.

Examples of the precipitation-hardening Examples of stainless steel include SUS630 (17-4PH) and SUS631 (17-7PH).

Examples of the austenitic-ferritic (duplex) stainless steel include SUS329J1, SUS329J3L, and SUS329J4L.

The above-described symbols are material symbols based on the JIS standards. The types of stainless steel in the specification are distinguished by the above-described material symbols.

The additive manufacturing powder 1 may be provided with a coating film that covers a surface of a core particle formed of the Fe-based metal material. The coating film is provided, for example, for a purpose of improving flowability and fillability of the additive manufacturing powder 1, and improving affinity between the additive manufacturing powder and the binder. Examples of a constituent material of the coating film include organic materials such as resins, inorganic materials such as ceramics and glass, and compounds derived from a coupling agent.

### 2.2. Various Characteristics of Additive Manufacturing Powder

Next, various characteristics of the additive manufacturing powder 1 will be described. All of the following characteristics are characteristics measured in a state in which the additive manufacturing powder 1 is not provided with the above-described coating film.

### 2.2.1. Evaluation PVP Aqueous Solution Permeation Depth

When an evaluation powder layer 10 is formed using the additive manufacturing powder 1 according to the embodiment, the evaluation powder layer 10 has a characteristic that a permeation depth of an evaluation PVP aqueous solution 40 falls within a predetermined range. The permeation depth of the evaluation PVP aqueous solution 40 in the evaluation powder layer 10 is an indicator quantitatively representing permeability to the binder solution 4 in the binder jet method described above. By optimizing such an indicator, it is possible to obtain the additive manufacturing powder 1 with which the powder layer 31 having excellent permeability to the binder solution 4 even when the particle diameter of the additive manufacturing powder 1 is small can be formed.

The evaluation PVP aqueous solution 40 is used to quantitatively represent the permeability to the binder solution 4 used in the binder jet method. The evaluation PVP aqueous solution 40 is an aqueous solution containing PVP and 2-butoxyethanol. In the evaluation PVP aqueous solution 40, a content of PVP (polyvinylpyrrolidone) is 8 masso, a content of 2-butoxyethanol is 2 mass %, and remainder is ion-exchanged water. Viscosity of the evaluation PVP aqueous solution 40 is 0.006 [Pas] (6 cP).

A permeation depth d of the evaluation PVP aqueous solution 40 is measured as follows.

FIG. 11 is a cross-sectional view showing a method for measuring a depth to which the evaluation PVP aqueous solution 40 permeates the evaluation powder layer 10.

When the permeation depth d of the evaluation PVP aqueous solution 40 is measured, first, the additive manufacturing powder 1 is charged into a container 20 and compacted to form the evaluation powder layer 10. The evaluation powder layer 10 has a thickness of 10 mm and a relative density of 45% or more and 47% or less. A size of the evaluation powder layer 10 in a horizontal direction is set in consideration of spread of the evaluation PVP aqueous solution 40, and is, for example, 30 mm square or more. The relative density is calculated by dividing mass of the evaluation powder layer 10 by volume to calculate a density, and then dividing the density by a true density of the additive manufacturing powder 1.

Next, a plurality of droplets of the evaluation PVP aqueous solution 40 are ejected from an inkjet head 30 toward one place on the evaluation powder layer 10. Resolution of the used inkjet head 30 is 600 dpi, an ejection speed of the droplets is 7.17 m/sec, a total amount of the evaluation PVP aqueous solution 40 ejected to the one place is 1.36 mL, and a temperature is 23° C.

Next, the evaluation powder layer 10 is heated at 100° C. for 1 hour. Accordingly, ejected water in the evaluation PVP aqueous solution 40 is removed, and a range where the evaluation PVP aqueous solution 40 permeates is solidified.

Next, the solidified portion is extracted from the evaluation powder layer 10. Then, a length from a surface to a deepest portion of the evaluation powder layer 10 (a length of the solidified portion) is measured. A measurement result is the depth (permeation depth d) to which the evaluation PVP aqueous solution 40 permeates.

In the evaluation powder layer 10 using the additive manufacturing powder 1 according to the embodiment, the permeation depth d of the evaluation PVP aqueous solution 40 is 110 μm or more and 250 μm or less. According to the additive manufacturing powder 1 having the permeation depth within the above range, even when the particle diameter of the additive manufacturing powder 1 is small and particle surface energy is large, it is possible to form the powder layer 31 into which the aqueous binder solution 4 can sufficiently permeate. Therefore, when the additive manufacturing powder 1 is used for manufacturing the additively manufactured body 6 using the binder jet method, it is possible to obtain the additive manufacturing powder 1 with which the additively manufactured body 6 having high shape accuracy can be produced.

The permeation depth d is preferably 130 μm or more and 220 μm or less, and more preferably 150 μm or more and 200 μm or less.

When the permeation depth d is less than the lower limit value, the binder solution 4 cannot permeate into the target range in the binder solution supplying step S104, and the shape accuracy of the additively manufactured body 6 decreases. Since permeation is time-consuming, a modeling speed of the additively manufactured body 6 decreases. On the other hand, when the permeation depth d exceeds the upper limit value, in the binder solution supplying step S104, a permeation distance of the binder solution 4 is excessively large, so-called bleeding occurs, and thus the shape accuracy of the additively manufactured body 6 decreases.

In the ejected evaluation PVP aqueous solution 40, all droplets preferably permeate the evaluation powder layer 10 within 3 seconds, and more preferably within 1 second from when a last droplet is ejected. Accordingly, the modeling speed of the additively manufactured body 6 can be particularly increased.

### 2.2.2. Particle Size Distribution

For the additive manufacturing powder 1 according to the embodiment, when a volume-based particle size distribution is obtained using a laser diffraction type particle size distribution measuring apparatus, a particle diameter when a cumulative frequency is 10% from a small diameter side is defined as D10. Similarly, particle diameters when the cumulative frequency is 50%, 90%, and 99% from the small diameter side are defined as D50, D90, and D99. An example of the apparatus for measuring the e particle size distribution is Microtrac 9320-X100 manufactured by Nikkiso Co., Ltd.

The particle diameter D50 of the additive manufacturing powder 1 is 0 μm or more and less than 15.0 μm, preferably 3.0 μm or more and 12.0 μm or less, and more preferably 4.0 μm or more and 10.0 μm or less. Accordingly, it is possible to obtain both sinterability and flowability of the additive manufacturing powder 1. As a result, the dense additively manufactured body 6 having high modeling accuracy can be obtained, and by using the additively manufactured body 6, the metal sintered body having a high density and high surface accuracy can finally be produced.

When the particle diameter D50 is smaller than the lower limit value, particles of the additive manufacturing powder 1 easily aggregate. Therefore, the flowability of the additive manufacturing powder 1 decreases, and the density of the metal sintered body decreases. On the other hand, when the particle diameter D50 is larger than the upper limit value, the sinterability of the additive manufacturing powder 1 decreases, and the density of the metal sintered body decreases.

A ratio D10/D50 of the particle diameter D10 to the particle diameter D50 is preferably 0.30 or more and 0.70 or less, more preferably 0.35 or more and 0.60 or less, and still more preferably 0.42 or more and 0.55 or less. Accordingly, the particle diameter of the additive manufacturing powder 1 is relatively uniform, the flowability can be easily increased, and the sinterability can be ensured. When the ratio D10/D50 is less than the lower limit value, the particle size distribution is broad, and the flowability may decrease. On the other hand, when the ratio D10/D50 is larger than the upper limit value, the particle size distribution is, conversely, excessively narrow, it is difficult to increase the filling ratio, and the sinterability may decrease.

A ratio D90/D50 of the particle diameter D90 to the particle diameter D50 is preferably 1.50 or more and 2.70 or less, more preferably 1.70 or more and 2.60 or less, and still more preferably 1.90 or more and 2.50 or less. Accordingly, the particle diameter of the additive manufacturing powder is 1 relatively uniform, the flowability can be easily increased, and the sinterability can be ensured. When the ratio D90/D50 is less than the lower limit value, the particle size distribution is narrow, it is difficult to increase the filling ratio, and the sinterability may decrease. On the other hand, when the ratio D90/D50 exceeds the upper limit value, the particle size distribution is broad, and the flowability may decrease.

A particle diameter difference D90-D10 between the particle diameter D90 and the particle diameter D10 is 5.0 μm or more and 18.0 μm or less, preferably 8.0 μm or more and 15.0 μm or less, and more preferably 9.0 μm or more and 13.0 μm or less. Accordingly, the particle size distribution of the additive manufacturing powder 1 is sufficiently narrow, and high flowability is obtained. As a result, the fillability of the additive manufacturing powder 1 is improved, and a dense additively manufactured body 6 having high modeling accuracy can be obtained.

When the particle diameter difference D90-D10 is less than the lower limit value, the particle size distribution of the additive manufacturing powder 1 is extremely narrow, thus it is difficult to improve the filling ratio, and the sinterability decreases. Therefore, the density and the surface accuracy of the produced metal sintered body decrease. On the other hand, when the particle diameter difference D90-D10 exceeds the upper limit value, the particle size distribution of the additive manufacturing powder 1 is broad, and the flowability decreases. Therefore, the density and the surface accuracy of the produced sintered body decrease.

### 2.2.3. Specific Surface Area

A specific surface area of the additive manufacturing powder 1 is 0.05 [m²/g] or more and 0.25 [m²/g] or less, preferably 0.10 [m²/g] or more and 0.22 [m²/g] or less, and more preferably 0.15 [m²/g] or more and 0.20 [m²/g] or less. If the specific surface area is within the above range, the sinterability and the flowability of the additive manufacturing powder 1 can both be obtained. Since the surface energy is optimized, the permeation depth of the binder solution 4 is also optimized, and the binder solution 4 is allowed to quickly permeate into the target range. As a result, the dense additively manufactured body 6 having high modeling accuracy can be obtained, and by using the additively manufactured body 6, the metal sintered body having a high density and high surface accuracy can finally be produced.

When the specific surface area is less than the lower limit value, the sinterability of the additive manufacturing powder 1 decreases, and the density of the metal sintered body decreases. The permeation distance of the binder solution 4 is excessively long, and the modeling accuracy may decrease. On the other hand, when the specific surface area exceeds the upper limit value, although the sinterability of the additive manufacturing powder 1 is improved, the flowability of the additive manufacturing powder 1 decreases, and the density and the surface accuracy of the metal sintered body decrease. In addition, the permeation depth of the binder solution 4 is insufficient, and the binder solution 4 may not permeate into the target range.

The specific surface area of the additive manufacturing powder 1 is obtained using a BET method. As a specific surface area measuring apparatus, for example, a BET type specific surface area measuring apparatus HM1201-010 manufactured by Mountech Co., Ltd. may be used, and a specimen amount is 5 g.

### 2.2.4. Average Circularity

An average circularity of the additive manufacturing powder 1 is 0.85 or more and 0.99 or less, preferably 0.86 or more and 0.98 or less, and more preferably 0.87 or more and 0.97 or less. Accordingly, even when the particle diameter of the additive manufacturing powder 1 is small, the particles are easily rolled, and a filling state can be brought close to a close-packed state. As a result, it is possible to obtain both sinterability and flowability of the additive manufacturing powder 1. Since the surface energy is optimized, the permeation depth of the binder solution 4 is also optimized, and the binder solution 4 is allowed to quickly permeate into the target range. Accordingly, the dense additively manufactured body 6 having high modeling accuracy can be obtained, and by using the additively manufactured body 6, the metal sintered body having a high density and high surface accuracy can finally be produced.

When the average circularity is less than the lower limit value, since the average circularity is low, the flowability of the additive manufacturing powder 1 decreases and the filling ratio decreases. In addition, the permeation depth of the binder solution 4 is insufficient, and the binder solution 4 may not permeate into the target range. On the other hand, when the average circularity exceeds the upper limit value, difficulty in production increases, and production efficiency of the additive manufacturing powder 1 decreases. The permeation distance of the binder solution 4 is excessively long, and the modeling accuracy may decrease.

The average circularity of the additive manufacturing powder 1 is measured as follows.

First, an image (secondary electron image) of the additive manufacturing powder 1 is taken using a scanning electron microscope (SEM). Next, the obtained image is read into image processing software. As the image processing software, for example, image analysis type particle size distribution measurement software “Mac-View” manufactured by Mountech Co., Ltd. is used. An imaging magnification is adjusted such that 50 to 100 particles appear in one image. Then, a plurality of images are acquired to obtain images of a total of 300 or more particles.

Next, a circularity of the images of 300 or more particles is calculated using software, and an average value is obtained. The obtained average value is the average circularity of the additive manufacturing powder 1. When a circularity is represented by e, an area of a particle image is represented by S, and a perimeter of the particle image is represented by L, the circularity e is obtained using the following formula.

e=4πS/L²

### 2.2.5. Moisture Content

A moisture content of the additive manufacturing powder 1 is preferably 200 ppm or less, more preferably 30 ppm or more and 200 ppm or less, still more preferably 40 ppm or more and 150 ppm or less, and particularly preferably 50 ppm or more and 100 ppm or less. When the moisture content is within the above range, a decrease in the flowability due to adsorption of moisture is prevented. Therefore, the additive manufacturing powder 1 having excellent flowability is obtained. If the moisture content is within the above range, chargeability of the additive manufacturing powder 1 can be controlled within an appropriate range, and a decrease in the flowability due to charging can be prevented.

When the moisture content is smaller than the lower limit value, the additive manufacturing powder 1 is easily charged, and the flowability may decrease. On the other hand, when the moisture content exceeds the upper limit value, the moisture content of the additive manufacturing powder 1 is excessively large, which may cause a decrease in the flowability.

The moisture content of the additive manufacturing powder 1 is measured at 250° C. using a Karl Fischer method after the additive manufacturing powder 1 to be measured is left to stand in an environment at a temperature of 25° C. and a relative humidity of 50% for 1 hour or longer. For the measurement, for example, a moisture measuring apparatus CA-310 manufactured by Nittoseiko Analytech Co., Ltd. is used.

### 2.2.6. Oxygen Content

An oxygen content of the additive manufacturing powder 1 is preferably 1000 ppm or more and 4000 ppm or less, more preferably 1500 ppm or more and 3500 ppm or less, and still more preferably 2000 ppm or more and 3000 ppm or less in terms of a mass ratio. When the oxygen content is within the above range, it is possible to prevent a change over time in characteristics while reducing adsorption of moisture. Accordingly, the additive manufacturing powder 1 having high flowability and high storage stability is obtained. In addition, an oxide film having an appropriate thickness is easily formed on a particle surface of the additive manufacturing powder 1. Such an oxide film contributes to permeation of the binder solution 4.

When the oxygen content is less than the lower limit value, the oxide film located at the particle surface of the additive manufacturing powder 1 is thin, and a change over time is likely to occur. When the powder layer 31 is formed using the additive manufacturing powder 1, the permeability of the powder layer 31 to the binder solution 4 may decrease. On the other hand, when the oxygen content is more than the upper limit value, moisture is easily adsorbed, the moisture content increases, and the flowability of the additive manufacturing powder 1 may decrease. In addition, the sinterability of the additive manufacturing powder 1 may decrease.

The oxygen content of the additive manufacturing powder 1 is measured according to, for example, general rules for determination of oxygen in metallic materials specified in JIS Z 2613:2006. Specifically, measurement can be performed using an oxygen and nitrogen analyzer TC-300/EF-300 manufactured by LECO Corporation, an oxygen, nitrogen, and hydrogen analyzer ONH836 manufactured by LECO Corporation, or the like.

### 2.2.7. Apparent Density and Tapped Density

An apparent density of additive the manufacturing powder 1 is preferably 2.50 g/cm³ or more and 3.50 g/cm³ or less, more preferably 2.70 g/cm³ or more and 3.40 g/cm³ or less, and still more preferably 3.00 g/cm³ or more and 3.30 g/cm³ or less. When the apparent density is within the above range, favorable fillability can be ensured even in a natural state. Accordingly, when the powder layer 31 is formed using the additive manufacturing powder 1, the powder layer 31 having a high filling ratio can be formed. As a result, the dense additively manufactured body 6 having high modeling accuracy can be obtained, and by using the additively manufactured body 6, the metal sintered body having a high density and high surface accuracy can finally be produced.

The apparent density of the additive manufacturing powder 1 is measured according to a metal powder apparent density measurement method specified in JIS Z 2504:2012. In addition, for the measurement of the apparent density, a powder characteristic evaluation apparatus, Powder Tester (registered trademark) PT-X manufactured by Hosokawa Micron Corporation is preferably used. Before the apparent density is measured, the additive manufacturing powder 1 to be measured is preferably left to stand in an environment at a temperature of 25° C. and a relative humidity of 50% for 1 hour or longer.

A tapped density of the additive manufacturing powder 1 is preferably 4.20 g/cm³ or more and 4.90 g/cm³ or less, more preferably 4.40 g/cm³ or more and 4.80 g/cm³ or less, and still more preferably 4.50 g/cm³ or more and 4.70 g/cm³ or less. When the tapped density is within the above range, a high filling ratio can be obtained when the powder layer 31 is leveled by the modeling stage 23 or compressed by the roller 25. Accordingly, the dense additively manufactured body 6 having high modeling accuracy can be obtained, and by using the additively manufactured body 6, the metal sintered body having a high density and high surface accuracy can finally be produced.

The tapped density of the additive manufacturing powder 1 is measured by a powder characteristic evaluation apparatus, Powder Tester (registered trademark) PT-X manufactured by Hosokawa Micron Corporation. Before the tapped density is measured, the additive manufacturing powder 1 to be measured is preferably left to stand in an environment at a temperature of 25° C. and a relative humidity of 50% for 1 hour or longer.

A ratio of the tapped density to the apparent density of the additive manufacturing powder 1 is preferably 1.20 or more and 1.80 or less, more preferably 1.30 or more and 1.70 or less, and still more preferably 1.40 or more and 1.60 or less. When the ratio is within the above range, a difference in the filling ratio between the additive manufacturing powder 1 in a natural state and the additive manufacturing powder 1 after vibration, load, or the like is applied can be reduced. Therefore, deformation or the like of the additively manufactured body 6 due to the difference in the filling ratio can be prevented. As a result, the metal sintered body having high surface accuracy is obtained.

Although the ratio may be less than the lower limit value, difficulty in stably producing the additive manufacturing powder 1 having such characteristics may increase. On the other hand, when the ratio exceeds the upper limit value, the difference in the filling ratio is large, which may cause deformation or the like of the additively manufactured body 6.

A ratio of the tapped density to the true density of the additive manufacturing powder 1 is preferably 0.580 or more and 0.640 or less, more preferably 0.590 or more and 0.630 or less, and still more preferably 0.600 or more and 0.620 or less. When the ratio is within the above range, it is possible to obtain the additive manufacturing powder 1 that particularly increases a density of the powder layer 31 even when the particle diameter is small. As a result, the metal sintered body having a high density and high surface accuracy can be produced. In addition, the additively manufactured body 6 can be produced while reducing an amount of the used binder solution 4.

When the ratio of the tapped density to the true density is less than the lower limit value, the fillability of the additive manufacturing powder 1 may decrease or the required amount of the binder solution 4 may increase. On the other hand, when the ratio of the tapped density to the true density exceeds the upper limit value, the difficulty in producing the additive manufacturing powder 1 increases, Which may cause an increase in cost and a decrease in production efficiency.

### 3. Method for Producing Additive Manufacturing Powder

Next, an example of a method for producing the additive manufacturing powder 1 will be described.

The additive manufacturing powder 1 may be produced using any production method, and is manufactured, for example, using an atomization method. In the atomization method, a molten metal is caused to flow down from a crucible and collide with a fluid such as a liquid or a gas ejected at a high speed. The molten metal colliding with the fluid falls inertially, and therefore, at this time, becomes spherical droplets. As a result, it is possible to produce a metal powder having a high average circularity and a relatively small specific surface area despite a relatively small diameter. In addition, since the specific surface area is small, the moisture content can be reduced.

Examples of the atomization method include a water atomization method, a gas atomization method, and a rotary water jet atomization method, depending on a difference in a type of a cooling medium or an apparatus configuration.

Flow rate of the molten metal varies depending on an apparatus size and the like, and is preferably more than 1.0 [kg/min] and 20.0 [kg/min] or less, and more preferably 2.0 [kg/min] or more and 10.0 [kg/min] or less. Accordingly, it is possible to optimize an amount of the molten metal flowing down during a certain time, and thus a metal powder having a narrow particle size distribution and being sufficiently spherical can be efficiently produced. As a result, it is possible to produce a metal powder having a high average circularity and a relatively small specific surface area despite a relatively small diameter. In addition, since the specific surface area is small, the moisture content can be reduced.

A temperature (casting temperature) of the molten metal in the crucible is preferably set, with respect to a melting point Tm [° C.] of the constituent material of the additive manufacturing powder 1, to Tm+100° C. or higher and Tm+350° C. or lower, more preferably Tm+180° C. or higher and Tm+320° C. or lower, and still more preferably Tm+250° C. or higher and Tm+300° C. or lower. Accordingly, it is possible to ensure a time during which the molten metal is present longer than that in the related art when the molten metal is atomized and solidified using various atomization methods. As a result, it is possible to produce a metal powder having a small diameter, a high average circularity and a relatively small specific surface area.

In various atomization methods, an outer diameter of a fine stream when the molten metal flows down is not particularly limited, and is preferably 3.0 mm or less, more preferably 0.3 mm or more and 2.0 mm or less, and still more preferably 0.5 mm or more and 1.5 mm or less. Accordingly, the fluid can be easily and uniformly applied to the molten metal, and thus liquid droplets having an appropriate size can be easily and uniformly scattered. As a result, it is possible to produce the metal powder having the average particle diameter and the favorable average circularity as described above with a narrow particle size distribution.

The produced metal powder may be classified as necessary. Examples of classification methods include dry classification such as sieving classification, inertial classification, and centrifugal classification, and wet classification such as sedimentation classification.

### 4. Effects of Embodiment

As described above, the additive manufacturing powder 1 according to the embodiment is an additive manufacturing powder containing the Fe-based metal material and used for the binder jet method. In the volume-based cumulative particle size distribution curve measured using the laser diffraction method, the additive manufacturing powder 1 has the particle diameter D50 of 1.0 μm or more and less than 15.0 μm, and the particle diameter difference D90-D10 between the particle diameter D90 and the particle diameter D10 of 5.0 μm or more and 18.0 μm or less, where D10 is the particle diameter when the cumulative value from the small diameter side is 10%, D50 is the particle diameter when the cumulative value from the small diameter side is 50%, and D90 is the particle diameter when the cumulative value from the small diameter side is 90%. The additive manufacturing powder 1 has a specific surface area of 0.05 [m²/g] or more and 0.25 [m²/g] or less, and an average circularity of 0.85 or more and 0.99 or less. Further, when a plurality of droplets of a total of 1.36 mL of the evaluation PVP aqueous solution 40 are dropped at the same position on the evaluation powder layer 10 compacted to have a relative density of 45% or more and 47% or less and a thickness of 10 mm, a depth to which the evaluation PVP aqueous solution 40 permeates (permeation depth d) is 110 μm or more and 250 μm or less.

According to such a configuration, it is possible to obtain the additive manufacturing powder 1 whose sinterability and flowability are both favorable and which has favorable permeability to the binder solution 4 (aqueous binder solution).

In the additive manufacturing powder 1 according to the embodiment, the oxygen content is 1000 ppm or more and 4000 ppm or less.

According to such a configuration, it is possible to prevent a change over time in characteristics while reducing adsorption of moisture. Accordingly, the additive manufacturing powder 1 having high flowability and high storage stability is obtained. In addition, the oxide film having the appropriate thickness is easily formed on the particle surface of the additive manufacturing powder 1. Such an oxide film contributes to permeation of the binder solution 4.

In the additive manufacturing powder 1 according to the embodiment, the particle diameter D50 is 4.0 μm or more and 10.0 μm or less, and the specific surface area is 0.10 [m²/g] or more and 0.22 [m²/g] or less.

According to such a configuration, it is possible to obtain both sinterability and flowability of the additive manufacturing powder 1. As a result, the additively manufactured body 6 that is dense and has high modeling accuracy can be obtained.

In the additive manufacturing powder 1 according to the embodiment, the moisture content measured at 250° C. using the Karl Fischer method is 200 ppm or less.

According to such a configuration, a decrease in the flowability due to adsorption of moisture is prevented. Therefore, the additive manufacturing powder 1 having excellent flowability is obtained. If the moisture content is within the above range, the chargeability of the additive manufacturing powder 1 can be controlled within the appropriate range, and a decrease in the flowability due to charging can be prevented.

In the additive manufacturing powder 1 according to the embodiment, the ratio of the tapped density to the apparent density is 1.20 or more and 1.80 or less.

According to such a configuration, the difference in the filling ratio between the additive manufacturing powder 1 in a natural state and the additive manufacturing powder 1 after vibration, load, or the like is applied can be reduced. Therefore, deformation or the like of the additively manufactured body 6 due to the difference in the filling ratio can be prevented. As a result, the metal sintered body having high surface accuracy is obtained.

In the additive manufacturing powder 1 according to the embodiment, the metal material is precipitation-hardening stainless steel.

According to such a configuration, an injection molding metal powder with which a metal sintered body excellent in mechanical strength and toughness can be produced is obtained.

In the additive manufacturing powder 1 according to the embodiment, the ratio of the tapped density to the true density is 0.580 or more and 0.640 or less.

According to such a configuration, it is possible to obtain the additive manufacturing powder 1 that particularly increases the density of the powder layer 31 even when the particle diameter is small. As a result, the metal sintered body having a high density and high surface accuracy can be produced. In addition, the additively manufactured body 6 can be produced while reducing the amount of the used binder solution 4.

The additively manufactured body 6 according to the embodiment contains the additive manufacturing powder 1 according to the embodiment and the binder that binds particles of the additive manufacturing powder 1.

According to such a configuration, due to the high flowability and the high fillability of the additive manufacturing powder 1, the dense additively manufactured body 6 having high modeling accuracy is obtained. Therefore, for example, the metal sintered body having a high density and surface accuracy can be obtained by sintering such an additively manufactured body 6.

Although the additive manufacturing powder and the additively manufactured body according to the disclosure are described above based on the shown embodiment, the disclosure is not limited thereto. For example, the additive manufacturing powder and the additively manufactured body according to the disclosure may be obtained by adding any component to the embodiment.

### Examples

Next, specific examples of the disclosure will be described.

### 5. Production of Additive Manufacturing Powder

An additive manufacturing powder in each of samples No. 1 to No. 23 was prepared using a water atomization method. A composition of the additive manufacturing powder in each sample No. is as shown Tables 1 to 4.

TABLE 1

| | Steel type | Category |
|---|---|---|
| Steel type 1 | SUS630 (17-4PH) | Precipitation-hardening stainless steel |
| Steel type 2 | SUS316L | Austenitic stainless steel |
| Steel type 3 | SUS420J2 | Martensitic stainless steel |

### 6. Acquisition of Characteristics of Additive Manufacturing Powder

For each additive manufacturing powder, a representative particle diameter, a specific surface area, an average circularity, an evaluation PVP aqueous solution permeation depth, an oxygen content, a moisture content, a ratio of a tapped density to an apparent density, and a ratio of the tapped density to a true density were measured. Measurement results are shown in Tables 2 to 4. In Tables 2 to 4, among the additive manufacturing powders of the respective samples No., those corresponding to the disclosure were each denoted as “Example”, and those not corresponding to the disclosure were each denoted as “Comparative Example”.

### 7. Evaluation of Additive Manufacturing Powder

### 7.1. Relative Density of Metal Sintered Body

Using the additive manufacturing powder of each sample No., an additively manufactured body having a rectangular parallelepiped shape was prepared using a binder jet method. A size of the prepared additively manufactured body was 40 mm in length, 20 mm in width, and 5 mm in thickness. A used binder solution was the same as an evaluation PVP aqueous solution.

Subsequently, the prepared additively manufactured body was subjected to a debindering treatment to remove the binder, and then was sintered in a furnace. A sintering condition in the case of the steel type 1 was 1100° C.×3 hours in an argon atmosphere. Accordingly, a metal sintered body was obtained. For the steel type 2 and the steel type 3, the sintering condition was selected according to a composition.

Next, a density of the obtained metal sintered body was measured. Next, a relative value of the measured density to the true density of the used additive manufacturing powder, that is, a relative density of the sintered body was calculated. Then, the calculated relative density was evaluated in view of the following evaluation criteria. Evaluation results are shown in Tables 2 to 4.
A: the relative density is 99.0% or more
B: the relative density is 98.5% or more and less than 99.0%
C: the relative density is 98.0% or more and less than 98.5%
D: the relative density is less than 98.0%.

### 7.2. Surface Roughness of Metal Sintered Body

Surface roughness of a largest surface of the obtained metal sintered body was measured. The surface roughness refers to arithmetic mean roughness Ra and was measured according to a method specified in JIS B 0671-1:2002. In Table 2, the surface roughness of each metal sintered body was relatively evaluated with reference to surface roughness of a metal sintered body produced using the additive manufacturing powder in sample No. 9. In Table 3, surface roughness of a metal sintered body produced using the additive manufacturing powder in sample No. 19 was used as a reference, and in Table 4, surface roughness of a metal sintered body produced using the additive manufacturing powder in sample No. 23 was used as a reference to perform the same relative evaluation. Evaluation results are shown in Tables 2 to 4.
A: a relative value of the surface roughness is less than 80% of a reference value
B: the relative value of the surface roughness is 80% or more and less than 90% of the reference value
C: the relative value of the surface roughness is 90% or more and less than 100% of the reference value
D: the relative value of the surface roughness is 100% or more of the reference value

TABLE 2

| | | Configuration of additive manufacturing powder | | | | | | | | | | | | | | | | |
|---|---|---|---|---|---|---|---|---|---|---|---|---|---|---|---|---|---|---|
| | | | | | | | | | | | | Eval- | | | | | | |
| | | | | | | | | | | | | uation | | | Ratio | | | |
| | | | | | | | | | | | | PVP | | | of | Ratio | Evaluation | |
| | | | | | | | | | | Spe- | | aqueous | | | tapped | of | result | |
| | | | | | | | | | | cific | Aver- | solution | Oxy- | Mois- | density | tapped | Sintered body | |
| | | | Representative particle diameter | | | | | | | sur- | age | per- | gen | ture | to | density | Rela- | Surface |
| Sam- | | | | | | | D90- | D10/ | D90/ | face | circu- | meation | con- | con- | apparent | to true | tive | rough- |
| ple | Classi- | Steel | D10 | D50 | D90 | D99 | D10 | D50 | D50 | area | larity | depth | tent | tent | density | density | density | ness |
| No. | fication | type | μm | μm | μm | μm | μm | — | — | m²/g | — | μm | ppm | ppm | — | — | — | — |
| 1 | Example | 1 | 3.4 | 7.1 | 14.3 | 20.9 | 10.9 | 0.48 | 2.01 | 0.175 | 0.92 | 162 | 2443 | 90 | 1.50 | 0.606 | A | A |
| 2 | Example | 1 | 3.4 | 7.0 | 17.4 | 33.7 | 14.0 | 0.49 | 2.49 | 0.195 | 0.87 | 145 | 2562 | 93 | 1.51 | 0.604 | A | A |
| 3 | Example | 1 | 2.9 | 6.8 | 15.4 | 24.1 | 12.5 | 0.43 | 2.26 | 0.236 | 0.87 | 118 | 3418 | 136 | 1.51 | 0.585 | B | A |
| 4 | Example | 1 | 3.7 | 7.5 | 14.5 | 22.0 | 10.8 | 0.49 | 1.93 | 0.155 | 0.94 | 198 | 2020 | 75 | 1.46 | 0.598 | A | A |
| 5 | Example | 1 | 2.9 | 6.9 | 15.5 | 24.3 | 12.6 | 0.42 | 2.25 | 0.220 | 0.86 | 132 | 3750 | 128 | 1.55 | 0.611 | B | A |
| 6 | Example | 1 | 1.8 | 3.2 | 8.6 | 15.1 | 6.8 | 0.56 | 2.69 | 0.245 | 0.94 | 231 | 3980 | 130 | 1.62 | 0.602 | B | A |
| 7 | Example | 1 | 4.1 | 10.3 | 19.4 | 24.3 | 15.3 | 0.40 | 1.88 | 0.136 | 0.85 | 245 | 1890 | 68 | 1.49 | 0.611 | A | B |
| 8 | Com- | 1 | 2.9 | 7.0 | 18.7 | 33.4 | 15.8 | 0.41 | 2.66 | 0.241 | 0.84 | 108 | 3369 | 141 | 1.72 | 0.552 | C | C |
| | parative | | | | | | | | | | | | | | | | | |
| | Example | | | | | | | | | | | | | | | | | |
| 9 | Com- | 1 | 2.9 | 7.1 | 19.0 | 34.2 | 16.1 | 0.41 | 2.68 | 0.257 | 0.78 | 96 | 3746 | 170 | 1.81 | 0.541 | D | — |
| | parative | | | | | | | | | | | | | | | | | |
| | Example | | | | | | | | | | | | | | | | | |
| 10 | Com- | 1 | 2.9 | 7.0 | 18.8 | 33.9 | 15.9 | 0.41 | 2.69 | 0.250 | 0.80 | 103 | 3623 | 167 | 1.79 | 0.544 | C | D |
| | parative | | | | | | | | | | | | | | | | | |
| | Example | | | | | | | | | | | | | | | | | |
| 11 | Com- | 1 | 2.8 | 7.2 | 19.3 | 34.4 | 16.5 | 0.39 | 2.68 | 0.249 | 0.81 | 99 | 3575 | 155 | 1.77 | 0.547 | C | C |
| | parative | | | | | | | | | | | | | | | | | |
| | Example | | | | | | | | | | | | | | | | | |
| 12 | Com- | 1 | 2.9 | 7.3 | 19.6 | 34.7 | 16.7 | 0.40 | 2.68 | 0.245 | 0.83 | 98 | 3420 | 151 | 1.74 | 0.549 | D | C |
| | parative | | | | | | | | | | | | | | | | | |
| | Example | | | | | | | | | | | | | | | | | |
| 13 | Com- | 1 | 2.6 | 7.2 | 21.4 | 36.7 | 18.8 | 0.36 | 2.97 | 0.241 | 0.85 | 112 | 3950 | 130 | 1.46 | 0.580 | C | C |
| | parative | | | | | | | | | | | | | | | | | |
| | Example | | | | | | | | | | | | | | | | | |
| 14 | Com- | 1 | 2.1 | 4.3 | 11.8 | 39.7 | 9.7 | 0.49 | 2.74 | 0.260 | 0.86 | 87 | 5430 | 134 | 1.80 | 0.525 | D | D |
| | parative | | | | | | | | | | | | | | | | | |
| | Example | | | | | | | | | | | | | | | | | |
| 15 | Com- | 1 | 4.5 | 16.0 | 28.0 | 45.0 | 23.5 | 0.28 | 1.75 | 0.126 | 0.94 | 58 | 750 | 56 | 1.36 | 0.589 | D | D |
| | parative | | | | | | | | | | | | | | | | | |
| | Example | | | | | | | | | | | | | | | | | |

TABLE 3

| | | Configuration of additive manufacturing powder | | | | | | | | | | | | | | | | |
|---|---|---|---|---|---|---|---|---|---|---|---|---|---|---|---|---|---|---|
| | | | | | | | | | | | | Eval- | | | Ratio | | | |
| | | | | | | | | | | | | uation | | | of | Ratio | | |
| | | | | | | | | | | | | PVP | | | | | Evaluation | |
| | | | | | | | | | | Spe- | | aqueous | | | tapped | of | result | |
| | | | | | | | | | | cific | Aver- | solution | Oxy- | Mois- | density | tapped | Sintered body | |
| | | | Representative particle diameter | | | | | | | sur- | age | per- | gen | ture | to | density | Rela- | Surface |
| Sam- | | Steel | | | | | D90- | D10/ | D90/ | face | circu- | meation | con- | con- | apparent | to true | tive | rough- |
| ple | Classi- | type | D10 | D50 | D90 | D99 | D10 | D50 | D50 | area | larity | depth | tent | tent | density | density | density | ness |
| No. | fication | — | μm | μm | μm | μm | μm | — | — | m²/g | — | μm | ppm | ppm | — | — | — | — |
| 16 | Example | 2 | 4.7 | 8.3 | 16.0 | 19.1 | 11.3 | 0.57 | 1.93 | 0.240 | 0.87 | 121 | 3110 | 95 | 1.50 | 0.584 | B | B |
| 17 | Example | 2 | 5.0 | 9.1 | 17.0 | 31.9 | 12.0 | 0.55 | 1.87 | 0.231 | 0.89 | 132 | 2980 | 83 | 1.46 | 0.596 | A | A |
| 18 | Example | 2 | 4.3 | 7.2 | 14.7 | 22.3 | 10.4 | 0.60 | 2.04 | 0.245 | 0.86 | 116 | 3240 | 100 | 1.55 | 0.588 | B | A |
| 19 | Com- | 2 | 2.5 | 9.0 | 21.0 | 36.0 | 18.5 | 0.28 | 2.33 | 0.380 | 0.72 | 103 | 3369 | 320 | 1.81 | 0.536 | D | — |
| | parative | | | | | | | | | | | | | | | | | |
| | Example | | | | | | | | | | | | | | | | | |
| 20 | Com- | 2 | 2.1 | 6.5 | 13.0 | 16.0 | 10.9 | 0.32 | 2.00 | 0.253 | 0.85 | 112 | 3746 | 189 | 1.78 | 0.578 | D | A |
| | parative | | | | | | | | | | | | | | | | | |
| | Example | | | | | | | | | | | | | | | | | |

TABLE 4

| | | Configuration of additive manufacturing powder | | | | | | | | | | | | | | | | |
|---|---|---|---|---|---|---|---|---|---|---|---|---|---|---|---|---|---|---|
| | | | | | | | | | | | | Eval- | | | | | | |
| | | | | | | | | | | | | uation | | | Ratio | | | |
| | | | | | | | | | | | | PVP | | | of | Ratio | Evaluation | |
| | | | | | | | | | | Spec- | | aqueous | | | tapped | of | result | |
| | | | | | | | | | | ific | Aver- | solution | Oxy- | Mois- | density | tapped | Sintered body | |
| | | | Representative particle diameter | | | | | | | sur- | age | per- | gen | ture | to | density | Rela- | Surface |
| Sam- | | Steel | | | | | D90- | D10/ | D90/ | face | circu- | meation | con- | con- | apparent | to true | tive | rough- |
| ple | Classi- | type | D10 | D50 | D90 | D99 | D10 | D50 | D50 | area | larity | depth | tent | tent | density | density | density | ness |
| No. | fication | — | μm | μm | μm | μm | μm | — | — | m²/g | — | μm | ppm | ppm | — | — | — | — |
| 21 | Example | 3 | 2.4 | 42 | 7.5 | 17.3 | 5.1 | 0.57 | 1.79 | 0.248 | 0.95 | 123 | 3850 | 185 | 1.45 | 0.612 | B | B |
| 22 | Example | 3 | 7.2 | 12.0 | 18.5 | 22.0 | 11.3 | 0.60 | 1.54 | 0.176 | 0.89 | 110 | 1230 | 50 | 1.65 | 0.605 | B | C |
| 23 | Com- | 3 | 2.2 | 5.3 | 17.0 | 36.0 | 14.8 | 0.42 | 3.21 | 0.350 | 0.78 | 96 | 4530 | 280 | 1.84 | 0.546 | D | — |
| | parative | | | | | | | | | | | | | | | | | |
| | Example | | | | | | | | | | | | | | | | | |

### 7.3. Consideration on Evaluation Results

As shown in Tables 2 to 4, it was recognized that the metal sintered body produced using the additive manufacturing powder of each Example had a high relative density and favorable surface roughness.

From the above, it was clear that the additive manufacturing powder in the disclosure can produce a metal sintered body having a high density and high surface accuracy.

What is claimed is:

1. An additive manufacturing powder for use in a binder jet method, comprising:
an Fe-based metal material, wherein
in a volume-based cumulative particle size distribution curve measured using a laser diffraction method, a particle diameter D50 is 1.0 μm or more and less than 15.0 μm, and a particle diameter difference D90-D10 between a particle diameter D90 and a particle diameter D10 is 5.0 μm or more and 18.0 μm or less, where D10 is a particle diameter when a cumulative value from a small diameter side is 10%, D50 is a particle diameter when the cumulative value from the small diameter side is 50%, and D90 is a particle diameter when the cumulative value from the small diameter side is 90%,
a specific surface area is 0.05 [m²/g] or more and 0.25 [m²/g] or less,
an average circularity is 0.85 or more and 0.99 or less, and
when a plurality of droplets of a total of 1.36 mL of an evaluation PVP aqueous solution are dropped at a same position on an evaluation powder layer compacted to have a relative density of 45% or more and 47% or less and a thickness of 10 mm, a depth to which the evaluation PVP aqueous solution permeates is 110 μm or more and 250 μm or less.

2. The additive manufacturing powder according to claim 1, wherein
an oxygen content is 1000 ppm or more and 4000 ppm or less.

3. The additive manufacturing powder according to claim 1, wherein
the particle diameter D50 is 4.0 μm or more and 10.0 μm or less, and
the specific surface area is 0.10 [m²/g] or more and 0.22 [m²/g] or less.

4. The additive manufacturing powder according to claim 1, wherein
a moisture content measured at 250° C. using a Karl Fischer method is 200 ppm or less.

5. The additive manufacturing powder according to claim 1, wherein
a ratio of a tapped density to an apparent density is 1.20 or more and 1.80 or less.

6. The additive manufacturing powder according to claim 1, wherein
the Fe-based metal material is precipitation-hardening stainless steel.

7. The additive manufacturing powder according to claim 6, wherein
a ratio of a tapped density to a true density is 0.580 or more and 0.640 or less.

8. An additively manufactured body comprising:
the additive manufacturing powder according to claim 1; and
a binder that binds particles of the additive manufacturing powder.
